(19) United States
(12) Patent Application Publication
(10) Pub. No.: US 2012/0037184 A1
(43) Pub. Date: Feb. 16, 2012

(54) Method Of Regulating Anaerobic Bacteria Load On a Skin Surface

(76) Inventors: Brian David Czetty, Sharonville, OH (US); Jeffrey Kenneth Domsic, Liberty, OH (US)

(21) Appl. No.: 13/208,656

(22) Filed: Aug. 12, 2011

Related U.S. Application Data
(60) Provisional application No. 61/373,499, filed on Aug. 13, 2010.

(51) Int. Cl. B08B 1/00; B08B 3/04

(52) U.S. Cl. 134/6

(57) ABSTRACT

A method for regulating anaerobic bacteria load on a skin surface may comprise a number of steps including determining a baseline anaerobic bacteria load of the skin surface; applying a cleansing composition to the skin surface; providing an automotive skin care device; contacting the treatment surface of the applicator to the skin surface for a contact time; rinsing the cleansing composition from the skin surface; repeating the treatment steps at least twice over a treatment period; and determining a post-treatment anaerobic bacteria load of the skin surface.

### CROSS REFERENCE TO RELATED APPLICATIONS

This application claims the benefit of U.S. Provisional Application No. 61/373,499, filed on Aug. 13, 2010.

### FIELD OF THE INVENTION

A method for reducing anaerobic bacteria load on a skin surface by using an automotive device with a cleanser.

### BACKGROUND OF THE INVENTION

Acne is a skin disorder characterized by follicle blockage preventing the natural drainage of sebum. Once blocked, bacteria and particularly anaerobic bacteria (such as Propionibacterium acnes) begin to develop in the collected sebum. The blocked follicles may then develop into non-inflamatory comedones (e.g., whiteheads or blackheads) or inflamatory lesions (e.g., papule, pustule, nodule, or cyst). Both non-inflamatory comedones and inflamatory lesions are visual indicators of acne and are a source of concern and embarrassment for sufferers.

Standard topical anti-acne agents, such as salicylic acid and benzoyl peroxide, have been known and used by consumers to treat acne for many years. Benzoyl peroxide is an antimicrobial that eradicates anaerobic bacteria. Benzoyl peroxide also serves to dry the skin which leads to increase skin turnover. Some individuals are allergic to benzoyl peroxide, and other users may experience undesirable dry, flaky skin with use. Salicylic acid is a chemical exfoliant that helps unclog blocked follicles. Prescription products exist for treating acne; each having a varying effectiveness as well as side effects. For example, one prescription product is a vitamin A derivative, isotretinoin, which carries warning as to teratogenicity.

In light of the current state of acne treatment, there exists a need for a method of treatment that effectively mitigates the underlying bacterial cause of the ailment. Coupled with the need for efficacy is a need for the treatment method to be gentle with no appreciable negative side effects.

### SUMMARY OF THE INVENTION

A method for regulating anaerobic bacteria load on a skin surface comprising the steps of (a) determining a baseline anaerobic bacteria load of the skin surface; (b) applying a cleansing composition to the skin surface; (c) providing an automotive skin care device, wherein the automotive skin care device comprises a housing with a handle end extending to an applicator attachment end, the housing contains a motor configured to impart motion to the applicator, and an applicator coupled to the housing at the applicator attachment end such that motion is imparted to the applicator from the motor, the applicator has a treatment surface; (d) contacting the treatment surface of the applicator to the skin surface for a contact time; (e) rinsing the cleansing composition from the skin surface; (f) repeating steps b-e at least twice over a treatment period; and (g) determining a post-treatment anaerobic bacteria load of the skin surface.

A method for regulating anaerobic bacteria load on a skin surface comprising the steps of (a) applying a cleansing composition to the skin surface, wherein the cleansing composition is substantially devoid of anti-acne actives; (b) providing an automotive skin care device, wherein the automotive skin care device comprises a housing with a handle end extending to an applicator attachment end, the housing contains a battery connected to a motor, wherein the motor is configured to impart rotational motion to the applicator, and an applicator coupled to the housing at the applicator attachment end such that motion is imparted to the applicator from the motor, the applicator has a treatment surface comprising bristles; (c) contacting the treatment surface of the applicator to the skin surface for at least 15 seconds; (d) rinsing the cleansing composition from the skin surface with water; and (e) repeating steps a-d at least twice with a daily interval.

In response to the technical problems identified in the background, the present invention may take other forms. Further forms of the present invention will be appreciated in the detailed description that follows.

### BRIEF DESCRIPTION OF THE DRAWINGS

It is believed that the present invention will be better understood from the following description taken in conjunction with the accompanying drawings. The referenced drawings are not to be construed as limiting the scope of present invention.

FIG. 1 is a side view of an automotive skin care device.

FIG. 2 is another view of the automotive skin care device of FIG. 1 with outer surfaces made transparent so that the internal componentry may be seen.

FIG. 3 is a front view of an automotive skin care device.

FIG. 4 is a partial exploded view of the automotive skin care device of FIG. 3 showing internal componentry.

FIG. 5 depicts a sampling matrix used during in vivo testing.

FIG. 6 is a plot of anaerobic bacteria load of a treated skin surface and an untreated skin surface.

### DETAILED DESCRIPTION OF THE INVENTION

All percentages and ratios used herein are by weight of the total composition and all measurements made are at 25° C., unless otherwise designated. All numeric ranges are inclusive of narrower ranges; delineated upper and lower range limits are interchangeable to create further ranges not explicitly delineated.

The compositions of the present invention can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

The term “apply” or “application” as used in reference to a composition, means to apply or spread the compositions of the present invention onto a human skin surface such as the epidermis.

The term “dermatologically acceptable” as used herein means that the compositions or components described are suitable for use in contact with human skin tissue without undue toxicity, incompatibility, instability, allergic response, and the like.

The term “safe and effective amount” as used herein means an amount of a compound or composition sufficient to significantly induce a positive benefit.

The term “facial skin surface” as used herein refers to one or more of forehead, periorbital, cheek, perioral, chin, and nose skin surfaces.

The term “baseline” as used in reference to bacteria load, means a measurement taken before start of the subject method. Typically, the baseline is taken proximate to the start of the method such as within about 24 hours of start.

The term “daily interval” as used herein means separated by approximately 24 hours. However, since the method is susceptible to user influence, needs, and demands; the time interval is approximate and may vary by several hours.

The term “automotive” as used herein means that the device is independently capable of motion without user manipulation other than by activating the device (i.e., turning the device on).

### I. DEVICE

The method for regulating anaerobic bacteria load on a skin surface comprises an automotive skin care device and a cleansing composition. The automotive skin care device generally comprises a housing and an applicator. The housing may comprise a handle end extending to an applicator attachment end. The housing may contain the components enabling the device to be automotive. For example, the housing may contain a motor configured to impart rotary, vibratory, oscillatory, or reciprocatory motion to the applicator. The applicator may be joined to the motor via a drive shaft or axle. The applicator may be joined to the motor via one or more gears. The housing may further comprise an on-off switch to control actuation of the motor. The housing may further comprise a speed control switch to control the speed, rotational speed, or frequency conveyed to the applicator.

The applicator may be coupled to the housing at the applicator attachment end. The applicator may be coupled such that motion is imparted to the applicator from the motor. The applicator has a treatment surface that is applied to a skin surface. The treatment surface of the applicator may comprise any dermatologically acceptable material. Suitable treatment surfaces include a bristles, foam, fabric, nonwoven substrate, pumice stone, emery board, and the like.

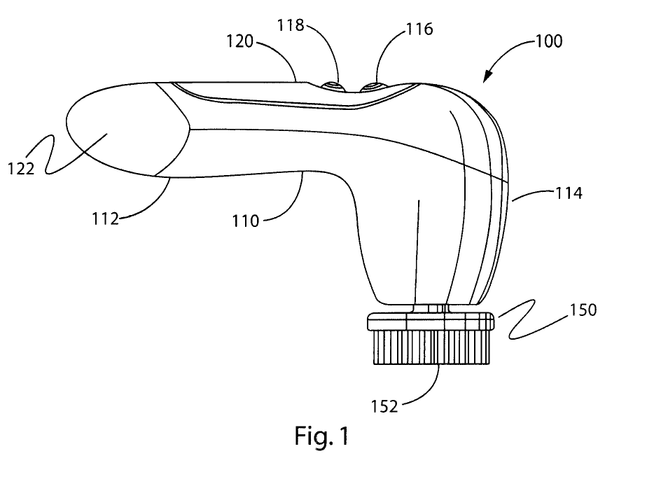

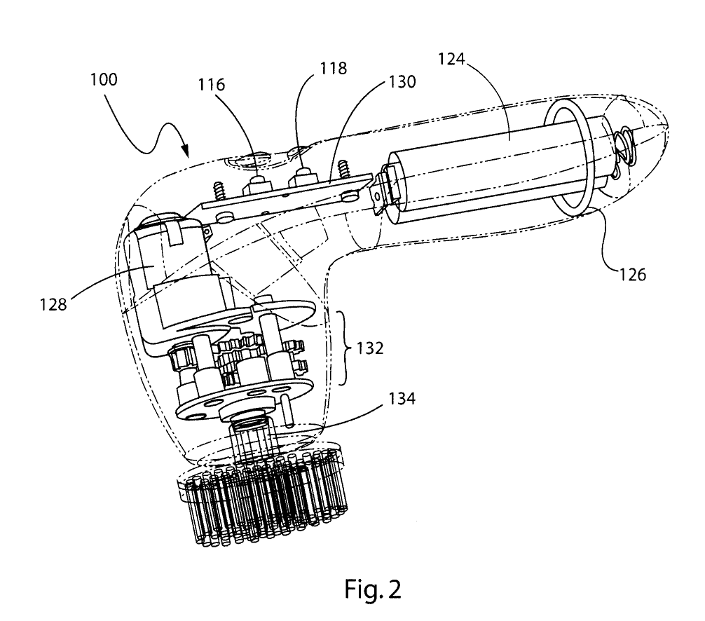

The following are suitable automotive skin care devices for use with the present method for regulating anaerobic bacteria load on a skin surface. FIGS. 1 and 2 depict a suitable automotive skin care device 100. FIG. 1 is a side view of the device 100 and FIG. 2 depicts the outer surfaces as transparent so that the internal componentry of the device 100 may be seen. The device 100 may comprises a housing 110 and an applicator 150. The housing 110 has a handle end 112 and an applicator end 114. The handle end 112 is shaped to allow easy control and manipulation by the hand. The housing 110 comprises an on-off switch 116 and a speed control switch 118. The switches 116, 118 may be covered with a water-resistant barrier 120 to protect the internal componentry. The water-impermeable barrier 120 may be a polymeric material such as an elastomeric sheet joined to the housing. The housing 110 also comprises a battery cover 122. The battery cover 122 may be releasably connected to the housing 110 allowing for replacement of batteries 124, as shown in FIG. 2. An O-ring 126 may be positioned between the housing 110 and the battery cover 122. The O-ring 126 ideally provides a water-resistant seal. The batteries 124 may disposable or rechargeable. While not shown in this embodiment, the device 100 may be configured to be run directly from AC current via a cord. The batteries 124 are connected to a motor 128 via a circuit board 130. The circuit board 130 is connected to the on-off switch 116 and a speed control switch 118. The circuit board 130 may be programmed to terminate and activate flow of electricity from the batteries 124 upon activation of the on-off switch 116. Likewise, the circuit board 130 may be programmed to regulate current flow (and resultantly actuator speed) from the batteries 124 upon activation of the speed control switch 118. The motor 128 is connected to a plurality of gears 132. The gears 132 convey the rotational motion of the motor 128 to an output shaft 134. The applicator 150 is connected to the housing 110 at the applicator end 114 via the output shaft 134. The applicator 150 may be releasably joined to the output shaft 134. The applicator 150 may be releasably attached by conventional means such as a threaded fitting or a snap-on/latch type fitting. When the device 100 is activated, the applicator 150 may rotate at a speed from about 250 to about 450 revolutions per minute under no load. The speed control switch 118 may be designed to provide multiple speed settings for the applicator 150. In one embodiment, the speed control switch 118 may provide a low speed setting (e.g., about 300 rpm) and a high speed setting (e.g., about 400 rpm). The applicator 150 has a treatment surface 152. The treatment surface 152 is formed from a plurality of bristles 154. While not shown in this embodiment, the treatment surface 152 of the applicator 150 may be formed from various other dermatologically acceptable materials.

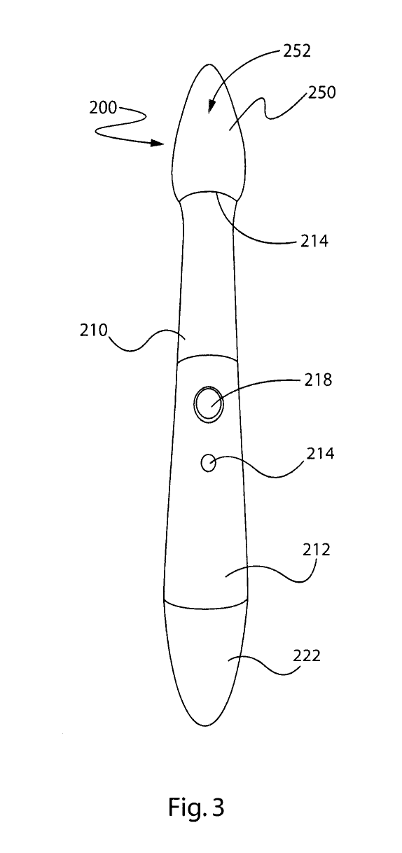

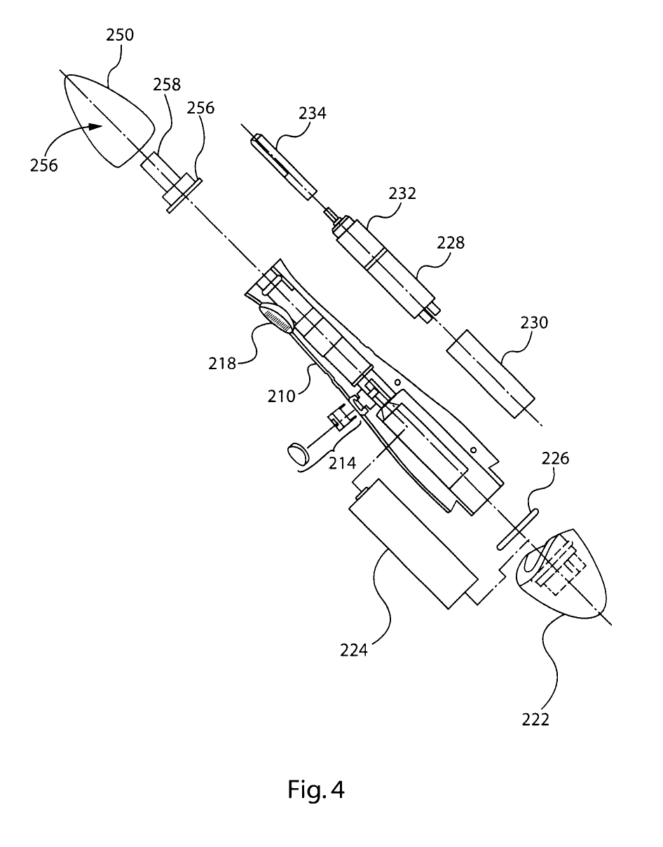

FIGS. 3 and 4 depict another suitable automotive skin care device 200. The automotive skin care device 200 has a housing 210 with a contoured shape from an applicator end 214 to an elongated ovoid handle end 212. As seen in FIG. 3, housing 210 is configured to rest comfortably in a user's hand. The device 200 has an on-off switch 214 located along housing 104. Optionally, the switch 214 may be covered with a water-resistant barrier to protect the internal componentry. The housing 210 also comprises a battery cover 222. The battery cover 222 may be releasably connected to the housing 210 allowing for replacement of battery 224, as shown in FIG. 4. An O-ring 226 may be positioned between the housing 210 and the battery cover 222. The O-ring 226 ideally provides a water-resistant seal. The batteries 224 may disposable or rechargeable. While not shown in this embodiment, the device 100 may be configured to be run directly from AC current via a cord.

The battery 224 is connected to a motor 228 via a circuit board 230. The circuit board 230 is connected to the on-off switch 214 and a speed control switch, if present. The circuit board 230 may be programmed to terminate and activate flow of electricity from the battery 224 upon activation of the on-off switch 214 Likewise, the circuit board 230 may be programmed to regulate current flow (and resultantly actuator speed) from the battery 224 upon activation of the speed control switch, if present. The motor 228 is connected to a gear box 232. The gearbox 232 convey the rotational motion of the motor 228 to an output shaft 234.

The applicator 250 comprises an attachment base 256 and attachment shaft 258. The attachment shaft 258 enables the device to releasably engage the applicator 250. This release element is operatively coupled to an ejector control 218 so that the user can release or eject the attached applicator 250. In the illustrated embodiment, ejector control 218 is a slide mechanism that enables the user to eject the applicator 250. The applicator 250 has a treatment surface. In this embodiment, the treatment surface 252 is formed from foam. While not shown in this embodiment, the treatment surface 252 of the applicator 250 may be formed from various other dermatologically acceptable materials.

Other suitable automotive skin care devices for use with the present method for regulating anaerobic bacteria load on a skin surface include devices described in U.S. Patent Application Publication 2009/0124985A1. Another suitable automotive skin care device is commercially available within the Doctor's Dermatological Formula® Revolve 400X Micro-Polishing System (The Procter & Gamble Company, Cincinnati, Ohio).

### II. CLEANSING COMPOSITION

A variety of suitable cleansing compositions may be used in the present method. The following are suitable automotive skin care devices for use with the present method for regulating anaerobic bacteria load on a skin surface. The cleansing compositions are intended to be rinse-off products. The term “rinse-off” means that the product is applied to a skin surface and subsequently removed from the skin surface. Typically removal occurs within seconds to minutes after application. Removal may be done by a water rinse, wiping away the composition with a substrate, or by other suitable means.

The cleansing composition may comprise a surfactant. The surfactant serves to clean the skin and may provide an acceptable amount of lather for the user. The composition may comprise up to about 50%, about 30%, about 15%, or 10%, by weight of the composition, of a surfactant. The composition may comprise at least about 5%, about 3, about 1% by weight of the composition, of a surfactant. Suitable surfactants include those selected from the group consisting of anionic surfactants, nonionic surfactants, amphoteric surfactants, non-lathering surfactants, emulsifiers and mixtures thereof.

Suitable surfactants include those selected from the group consisting of anionic surfactants, nonionic surfactants, amphoteric surfactants, non-lathering surfactants, emulsifiers and mixtures thereof. Non-limiting examples of surfactants useful in the compositions of the present invention are disclosed in U.S. Pat. No. 6,280,757, to McAtee et al, issued Aug. 28, 2001.

A) Anionic Surfactants—Non-limiting examples of anionic surfactants useful in the compositions of the present invention are disclosed in McCutcheon's, Detergents and Emulsifiers, North American edition (1986), published by allured Publishing Corporation; McCutcheon's, Functional Materials, North American Edition (1992); and U.S. Pat. No. 3,929,678, to Laughlin et al., issued Dec. 30, 1975.

A wide variety of anionic surfactants are useful herein. Non-limiting examples of anionic surfactants include those selected from the group consisting of sarcosinates, sulfates, isethionates, taurates, phosphates, lactylates, glutamates, and mixtures thereof. Amongst the isethionates, the alkoyl isethionates are preferred, and amongst the sulfates, the alkyl and alkyl ether sulfates are preferred.

Other anionic materials useful herein are fatty acid soaps (i.e., alkali metal salts, e.g., sodium or potassium salts) typically having from a fatty acid having about 8 to about 24 carbon atoms, preferably from about 10 to about 20 carbon atoms. These fatty acids used in making the soaps can be obtained from natural sources such as, for instance, plant or animal-derived glycerides (e.g., palm oil, coconut oil, soybean oil, castor oil, tallow, lard, etc.) The fatty acids can also be synthetically prepared. Soaps and their preparation are described in detail in U.S. Pat. No. 4,557,853.

Other anionic materials include phosphates such as monoalkyl, dialkyl, and trialkylphosphate salts. Non-limiting examples of preferred anionic lathering surfactants useful herein include those selected from the group consisting of sodium lauryl sulfate, ammonium lauryl sulfate, ammonium laureth sulfate, sodium laureth sulfate, sodium trideceth sulfate, ammonium cetyl sulfate, sodium cetyl sulfate, ammonium cocoyl isethionate, sodium lauroyl isethionate, sodium lauroyl lactylate, triethanolamine lauroyl lactylate, sodium caproyl lactylate, sodium lauroyl sarcosinate, sodium myristoyl sarcosinate, sodium cocoyl sarcosinate, sodium lauroyl methyl taurate, sodium cocoyl methyl taurate, sodium lauroyl glutamate, sodium myristoyl glutamate, and sodium cocoyl glutamate and mixtures thereof.

B) Non-Ionic Surfactants—Non-limiting examples of nonionic surfactants for use in the compositions of the present invention are disclosed in McCutcheon's, Detergents and Emulsifiers, North American edition (1986), published by allured Publishing Corporation; and McCutcheon's, Functional Materials, North American Edition (1992).

Nonionic surfactants useful herein include those selected from the group consisting of alkyl glucosides, alkyl polyglucosides, polyhydroxy fatty acid amides, alkoxylated fatty acid esters, sucrose esters, amine oxides, and mixtures thereof.

Non-limiting examples of preferred nonionic surfactants for use herein are those selected form the group consisting of C8-C14 glucose amides, C8-C14 alkyl polyglucosides, sucrose cocoate, sucrose laurate, lauramine oxide, cocoamine oxide and mixtures thereof.

C) Amphoteric Surfactants—The term “amphoteric surfactant,” as used herein, is also intended to encompass zwitterionic surfactants, which are well known to formulators skilled in the art as a subset of amphoteric surfactants.

A wide variety of amphoteric lathering surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate.

Non-limiting examples of amphoteric surfactants useful in the compositions of the present invention are disclosed in McCutcheon's, Detergents and Emulsifiers, North American edition (1986), published by allured Publishing Corporation; and McCutcheon's, Functional Materials, North American Edition (1992).

Non-limiting examples zwitterionic surfactants are those selected from the group consisting of betaines, sultaines, hydroxysultaines, alkyliminoacetates, iminodialkanoates, aminoalkanoates, and mixtures thereof.

Preferred surfactants for use herein are the following, wherein the anionic surfactant is selected from the group consisting of ammonium lauroyl sarcosinate, sodium trideceth sulfate, sodium lauroyl sarcosinate, ammonium laureth sulfate, sodium laureth sulfate, ammonium lauryl sulfate, sodium lauryl sulfate, ammonium cocoyl isethionate, sodium cocoyl isethionate, sodium lauroyl isetlionate, sodium cetyl sulfate, sodium lauroyl lactylate, triethanolamine lauroyl lactylate, and mixtures thereof, wherein the non-ionic surfactant is selected from the group consisting of lauramine oxide, cocoamine oxide, decyl polyglucose, lauryl polyglucose, sucrose cocoate, C12_{—}14 glucosamides, sucrose laurate, and mixtures thereof; and wherein the amphoteric surfactant is selected from the group consisting of disodium lauroamphodiacetate, sodium lauroamphoacetate, cetyl dimethyl betaine, cocoamidopropyl betaine, cocoamidopropyl hydroxy sultaine, and mixtures thereof.

D) Non-Lathering Surfactants—A wide variety of non-lathering surfactants are useful herein. The composition of the present invention can comprise a sufficient amount of one or more non-lathering surfactants to emulsify the dispersed phase to yield an appropriate particle size and good application properties on wet skin.

Nonlimiting examples of these non-lathering compositions are: polyethylene glycol 20 sorbitan monolaurate (Polysorbate 20), polyethylene glycol 5 soya sterol, Steareth-20, Ceteareth-20, PPG-2 methyl glucose ether distearate, Ceteth-10, Polysorbate 80, cetyl phosphate, potassium cetyl phosphate, diethanolamine cetyl phosphate, Polysorbate 60, glyceryl stearate, PEG-100 stearate, polyoxyethylene 20 sorbitan trioleate (Polysorbate 85), sorbitan monolaurate, polyoxyethylene 4 lauryl ether sodium stearate, polyglyceryl 4 isostearate, hexyl laurate, steareth-20, ceteareth-20, PPG-2 methyl glucose ether distearate, ceteth-10, diethanolamine cetyl phosphate, glyceryl stearate, PEG-100 stearate, and mixtures thereof.

E) Emulsifiers—There are several commercial emulsifier mixtures that are useful in some embodiments. Examples include PROLIPID 141 (glyceryl stearate, behenyl alcohol, palmitic acid, stearic acid, lecithin, lauryl alcohol, myristyl alcohol and cetyl alcohol) and 151 (Glyceryl stearate, cetearyl alcohol, stearic acid, 1-propanamium, 3-amino-N-(2(hydroxyethyl)-N—N-Dimethyl,N—C(16-18) Acyl Derivatives, Chlorides) from ISP; POLAWAX NF (Emulsifying wax NF), INCROQUAT BEHENYL TMS (behentrimonium sulfate and cetearyl alcohol) from Croda; and EMULLIUM DELTA (cetyl alcohol, glyceryl stearate, peg-75 stearate, ceteth-20 and steareth-20) from Gattefosse.

The cleansing composition may further comprise one or more thickening agent. In certain embodiments when present, the cleansing composition comprises no more than about 15%, about 10%, or about 5%, by weight of the composition, of a thickening agent. In other embodiments when present, the cleansing composition comprises at least about 0.01%, about 0.05%, or about 0.1%, by weight of the composition, of a thickening agent. The thickening agent may provide the cleansing composition with a viscosity of at least 1000 cps, at least 1500 cps, or at least 2000 cps.

Nonlimiting examples of thickening agents useful herein include carboxylic acid polymers such as the carbomers (such as those commercially available under the tradename CARBOPOL® 900 series from B.F. Goodrich; e.g., CARBOPOL® 954). Other suitable carboxylic acid polymeric agents include copolymers of C10_{—}30 alkyl acrylates with one or more monomers of acrylic acid, methacrylic acid, or one of their short chain (i.e., C1_{—}4 alcohol) esters, wherein the crosslinking agent is an allyl ether of sucrose or pentaerytritol. These copolymers are known as acrylates/C alkyl acrylate crosspolymers and are commercially available as CARBOPOL® 1342, CARBOPOL® 1382, PEMULEN TR-1, and PEMULEN TR-2, from B.F. Goodrich. Other nonlimiting examples of thickening agents include crosslinked polyacrylate polymers including both cationic and nonionic polymers. Still other nonlimiting examples of thickening agents include the polyacrylamide polymers, especially nonionic polyacrylamide polymers including substituted branched or unbranched polymers. Suitable polyacrylamide polymers include SEPIGEL 305 (INCI designation Polyacrylamide and C-13-14 Isoparaffin and Laureth-7), SIMULGEL EG (Sodium Acrylate/Sodium Acryloyldimethyl Taurate Copolymer and Isohexadecane and Polysorbate 80), and SIMULGEL NS (Hydroxyethyl Acrylate/Sodium Acryloyldimethyl Taurate Copolymer and Squalene and Polysorbate 60) available from Seppic Corporation (Fairfield, N.J.). Other polyacrylamide polymers useful herein include multi-block copolymers of acrylamides and substituted acrylamides with acrylic acids and substituted acrylic acids. Commercially available examples of these multi-block copolymers include HYPAN SR150H, SS500V, SS500W, SSSA100H, from Lipo Chemicals, Inc., (Patterson, N.J.).

Another nonlimiting class of thickening agents useful herein is the polysaccharides. Nonlimiting examples of polysaccharide gelling agents include those selected from cellulose, and cellulose derivatives. Preferred among the alkyl hydroxyalkyl cellulose ethers is the material given the CTFA designation cetyl hydroxyethylcellulose, which is the ether of cetyl alcohol and hydroxyethylcellulose, sold under the tradename NATROSEL® CS PLUS from Aqualon Corporation (Wilmington, Del.). Other useful polysaccharides include scleroglucans which are a linear chain of (1-3) linked glucose units with a (1-6) linked glucose every three units, a commercially available example of which is CLEAROGEL™ CS11 from Michel Mercier Products Inc. (Mountainside, N.J.).

Another nonlimiting class of thickening agents useful herein are the gums. Nonlimiting examples of gums useful herein include hectorite, hydrated silica, xantham gum, and mixtures thereof.

Yet another nonlimiting class of thickening agents useful herein are the modified starches. Acrylate modified starches such as WATERLOCK® from Grain Processing Corporation may be used. Hydroxypropyl starch phosphate, tradename STRUCTURE XL from National Starch is another example of a useful modified starch, and other useful examples include ARISTOFLEX HMB (Ammonium Acrylodimethyltaruate/Beheneth-25 Methacrylate Crosspolymer) from Clariant.

The present invention may also contain a cationic polymer. Concentrations of the cationic polymer preferably range from about 0.025% to about 3%, more preferably from about 0.05% to about 2%, even more preferably from about 0.1% to about 1%, by weight of the personal care composition.

Suitable cationic deposition polymers for use in the present invention contain cationic nitrogen-containing moieties such as quaternary ammonium or cationic protonated amino moieties. The cationic protonated amines can be primary, secondary, or tertiary amines (preferably secondary or tertiary), depending upon the particular species and the selected pH of the personal cleansing composition. The average molecular weight of the cationic polymer is between about 5,000 to about 10 million, preferably at least about 100,000, more preferably at least about 200,000, but preferably not more than about 2 million, more preferably not more than about 1.5 million Dalton. The polymers also have a cationic charge density ranging from about 0.2 meq/g to about 5 meq/g, preferably at least about 0.4 meq/g, more preferably at least about 0.6 meq/g., at the pH of intended use of the personal cleansing composition, which pH will generally range from about pH 4 to about pH 9, or between about pH 5 and about pH 8.

Nonlimiting examples of cationic deposition polymers for use in the personal care composition include polysaccharide polymers, such as cationic cellulose derivatives. Preferred cationic cellulose polymers are the salts of hydroxyethyl cellulose reacted with trimethyl ammonium substituted epoxide, referred to in the industry as Polyquaternium 10 which are available from Amerchol Corp. (Edison, N.J., USA) in their Polymer KG, JR and LR series of polymers with the most preferred being KG-30M.

Other suitable cationic deposition polymers include cationic guar gum derivatives, such as guar hydroxypropyltrimonium chloride, specific examples of which include the Jaguar series (preferably Jaguar C-17) commercially available from Rhodia Inc., and N-Hance polymer series commercially available from Aqualon. Other suitable cationic deposition polymers include synthetic cationic polymers. A non limiting example of a commercially available synthetic cationic polymer for use in the cleansing compositions is polymethyacrylamidopropyl trimonium chloride, available under the trade name POLYCARE 133, from Rhodia, Cranberry, N.J., U.S.A.

The cleansing composition may contain a variety of other ingredients. When present, compositions of the present invention may contain from about 0.0001% to about 50%; from about 0.001% to about 20%; or, alternately, from about 0.01% to about 10%, by weight of the composition, of the optional components. The amounts listed herein are only to be used as a guide, as the optimum amount of the optional components used in a composition will depend on the specific active selected since their potency does vary considerably. Hence, the amount of some optional components useful in the present invention may be outside the ranges listed herein.

The optional components, when incorporated into the composition, should be suitable for use in contact with human skin tissue without undue toxicity, incompatibility, instability, allergic response, and the like. The compositions of the present invention may include optional components such as anti-acne actives, desquamation actives, anti-cellulite agents, chelating agents, flavonoids, tanning active, non-vitamin antioxidants and radical scavengers, hair growth regulators, anti-wrinkle actives, anti-atrophy actives, minerals, phytosterols and/or plant hormones, N-acyl amino acid compounds, antimicrobial or antifungal actives, and other useful skin care actives, which are described in further detail in U.S. application publication No. US2006/0275237A1 and US2004/0175347A1.

In one embodiment, the cleansing composition is substantially devoid of anti acne actives. Exemplary anti-acne actives include resorcinol, sulfur, erythromycin, salicylic acid, and benzoyl peroxide. The term “substantially devoid” in reference to anti acne actives means that there is either no anti-acne actives present or that the anti-acne actives are present at a level lower than what is recognized as being efficacious for the treatment of acne

In one embodiment, the cleansing composition is substantially devoid of antimicrobial actives. Exemplary antimicrobial actives include pyrithiones especially the zinc complex (ZPT), Octopirox®, dimethyldimethylol hydantoin (Glydant®), methylchloroisothiazolinone/methylisothiazolinone (Kathon CG®), sodium sulfite, sodium bisulfite, imidazolidinyl urea (Germall 115C)), diazolidinyl urea (Germaill II®), benzyl alcohol, 2-bromo-2-nitropropane-1,3-diol (Bronopol®), formalin (formaldehyde), iodopropenyl butylcarbamate (Polyphase P100®), chloroacetamide, methanamine, methyldibromonitrile glutaronitrile (1,2-Dibromo-2,4-dicyanobutane or Tektamer®), glutar aldehyde, 5-bromo-5-nitro-1,3-dioxane (Bronidox®), phenethyl alcohol, o-phenylphenol/sodium o-phenylphenol, sodium hydroxymethylglycinate (Suttocide A®), polymethoxy bicyclic oxazolidine (Nuosept C®), dimethoxane, thimersal, dichlorobenzyl alcohol, captan, chlorphenenesin, dichlorophene, chlorbutanol glyceryl laurate, halogenated diphenyl ethers, phenolic compounds, mono- and poly-alkyl and aromatic halophenols, resorcinol compounds, benzoic esters (Parabens), or halogenated carbanilides. Additional suitable antimicrobial actives are listed in U.S. Pat. No. 6,113,933. The term “substantially devoid” in reference to antimicrobial actives means that either no antimicrobial actives are present or that the antimicrobial actives are present at a level lower than what is recognized as being efficacious for an antibacterial or antimicrobial benefit on skin. In one embodiment, substantially devoid of antimicrobial actives means that antimicrobial actives comprise less than about 0.001% or about 0.0005%, by weight, of the composition.

The Personal Care Product Council's International Cosmetic Ingredient Dictionary and Handbook, Thirteenth Edition, describes a wide variety of non-limiting cosmetic and pharmaceutical ingredients commonly used in the skin care industry, which are suitable optional components for use in the compositions of the present invention. Examples of these ingredient classes include: abrasives, absorbents, aesthetic components such as fragrances, pigments, colorings/colorants, essential oils, anti-caking agents, antifoaming agents, antimicrobials, binders, biological additives, buffering agents, bulking agents, chelating agents, chemical additives, colorants, cosmetic astringents, cosmetic biocides, denaturants, drug astringents, emollients, external analgesics, film formers or materials, opacifying agents, pH adjusters, preservatives, propellants, reducing agents, sequestrants, skin cooling agents, skin protectants, thickeners viscosity modifiers, vitamins, and combinations thereof.

The cleansing compositions of the present invention may also comprise a dermatologically acceptable carrier (which may be referred to as “carrier”). In one embodiment, the carrier is present at a level of from about 50% to about 99%, about 60% to about 98%, about 70% to about 98%, or, alternatively, from about 80% to about 95%, by weight of the composition.

The carrier can be in a wide variety of forms. Non-limiting examples include simple solutions (e.g., aqueous, organic solvent, or oil based), emulsions, and solid forms (e.g., gels, sticks, flowable solids, or amorphous materials). In certain embodiments, the dermatologically acceptable carrier is in the form of an emulsion. Emulsion may be generally classified as having a continuous aqueous phase (e.g., oil-in-water and water-in-oil-in-water) or a continuous oil phase (e.g., water-in-oil and oil-in-water-in-oil). The oil phase of the present invention may comprise silicone oils, non-silicone oils such as hydrocarbon oils, esters, ethers, and the like, and mixtures thereof. The aqueous phase typically comprises water. However, in other embodiments, the aqueous phase may comprise components other than water, including but not limited to water-soluble moisturizing agents, conditioning agents, anti-microbials, humectants and/or other water-soluble skin care actives. In one embodiment, the non-water component of the composition comprises a humectant such as glycerin and/or other polyols. However, it should be recognized that the composition may be substantially (i.e., less than 1% water) or fully anhydrous.

### III. METHOD

Various steps may comprise the present method for regulating anaerobic bacteria load on a skin surface. Other methods are envisaged comprising any combination of one or more of the below mentioned steps. The skin surface is not limited but the method may be directed to a skin surface exhibiting or susceptible to acne. In certain embodiments, the skin surface may be a facial skin surface. The method may further involve the step of identifying a skin surface in need of anaerobic bacteria regulation. Identification may be done by visual inspection of acne lesions. Alternately, identification may be done by anaerobic bacteria counting, which is described in further detail below.

The method may comprise the step of wetting the skin surface to be treated with water. Wetting may improve the efficacy of the cleansing composition. However, particularly with cleansing compositions with a high water percentage, wetting the skin surface with water may be unnecessary. Wetting may be done by placing the skin surface under running water, in a basin of water, or by splashing water onto the skin surface.

The method may comprise the step(s) of determining the baseline and/or the post treatment anaerobic bacteria load of the skin surface. The anaerobic bacteria load may be measured by obtaining a baseline and/or a post-treatment sample of anaerobic bacteria from the skin surface. Sampling can be done by contact methods such as swabbing, tape stripping, flushing, or like methods. Sampling should be performed in a manner that is consistent amongst each sample. The sample may require culturing so as to produce bacteria at more measurable level. Culturing of the sample may be performed under anaerobic conditions to promote growth of the anaerobic bacteria and inhibit growth of aerobic bacteria. Culturing may be performed according to conventional biological methods. Culturing of the samples should be performed in a routine manner to insure that all samples are subjected to like conditions. The anaerobic bacteria colonies of the sample are counted to receive a baseline anaerobic bacteria count. Colony counting may be performed by a naked eye count or may be device-aided. Colony counting may be performed by automatic colony counters which are well known in the industry. A suitable method for determining baseline and post-treatment anaerobic bacteria load is provided in the Example section.

The method comprises the step of applying a cleansing composition to the skin surface. The cleansing composition may be applied to a pre-wetted skin surface. While the amount of cleansing composition is not particularly limited, a dose of about 0.1 mL to about 1 mL of the cleansing composition is typically sufficient, especially for cleansing of the facial skin surface. The cleansing composition may be applied to the skin surface by finger application. Alternately, the cleansing composition may be first dispensed onto the device applicator and then applied to the skin surface.

The method comprises providing an automotive skin care device. Any of the aforementioned automotive skin care devices with an applicator having a treatment surface may be used in the method. The method further comprises the step of contacting the treatment surface of the moving applicator to the skin surface. Gentle pressure may be applied to maintain the treatment surface in contact with the skin surface. Pressure should not be excessive such that it significantly reduces the speed with which the applicator moves. The treatment surface is maintained in contact with the skin surface for a contact time. In one embodiment, the contact time is at least about 5, about 10, or about 15 seconds. In other embodiments, the contact time may be at least about 30 seconds, about 45 second, or about 60 seconds. Excessive contact time causing redness, irritation, or sensitivity should be avoided. The exact contact time is conditioned on the form of the applicator treatment surface, the cleansing composition, and the condition of the skin surface.

In some instances the skin surface to be regulated is larger than the area of the treatment surface. In such instances, the device may be moved by hand so that the treatment surface of the applicator contacts all areas of the skin surface requiring regulation. For example, the device may be manipulated so that the treatment surface of the applicator contacts a first skin surface for a first contact time and then is moved to contact a second skin surface for a second contact time. Ideally, all points on the skin surface requiring regulation will receive approximately the same amount of contact time with the treatment surface, so the first and second contact times may be equal. However, given that a user may not be precise in the movement or use of the device, the first and second contact times will likely vary. The method may involve moving the so that the treatment surface of the applicator contacts a third, fourth, etc. skin surface for a third, fourth, etc. contact time.

The cleansing composition may be removed from the skin surface. The removal of the cleansing composition typically may occur shortly after regulation or treatment by the device. Removal of the cleansing composition may involve rinsing the skin surface with water. Removal of the cleansing composition may involve wiping away the composition with a substrate or by other like suitable means.

Any combination of the aforementioned steps may be repeated. The steps may be repeated numerous times. Ideally, the steps are repeated at least twice (i.e., three cycles). The repetition may occur at a given interval over a treatment period. The steps may be repeated at an interval of between about 4 and about 36 hours. Alternately, the steps may be repeated at a daily interval or may be used twice daily. The method may be performed when convenient for the user such as during a morning and/or evening routine. The treatment period be over one or more days. The treatment period may be over one or more weeks. In order to continually regulate anaerobic bacteria load on the skin, the treatment period may last months to years given the needs of the user. In one embodiment, the treatment period extends until no non-inflamatory comedones or inflamatory lesions are visible. In another embodiment, the treatment period extends at least three days with repetition of the steps at a daily interval.

### IV. EXAMPLES

The following example is provided to illustrate certain features and advantages of various embodiments of the invention and should not be construed as limiting the scope thereof. An eight day in vivo study was conducted using a controlled, split face design with 12 subjects. For each participant, one side of the face was treated and the other side of the face was left untreated. Each participant is instructed (i) to not wash her face with soap, (ii) to not use any skin care or cosmetic products on her face, and (iii) to not use antidandruff shampoos or topical or systemic anti-microbials or treatments during the test period (aside from those comprising the treatment protocol). Participants are instructed to avoid touching their face during the test period. Participants are allowed to do a water only rinse of the face during the test period. Participants are prescreened to exclude individuals on antibiotic treatments.

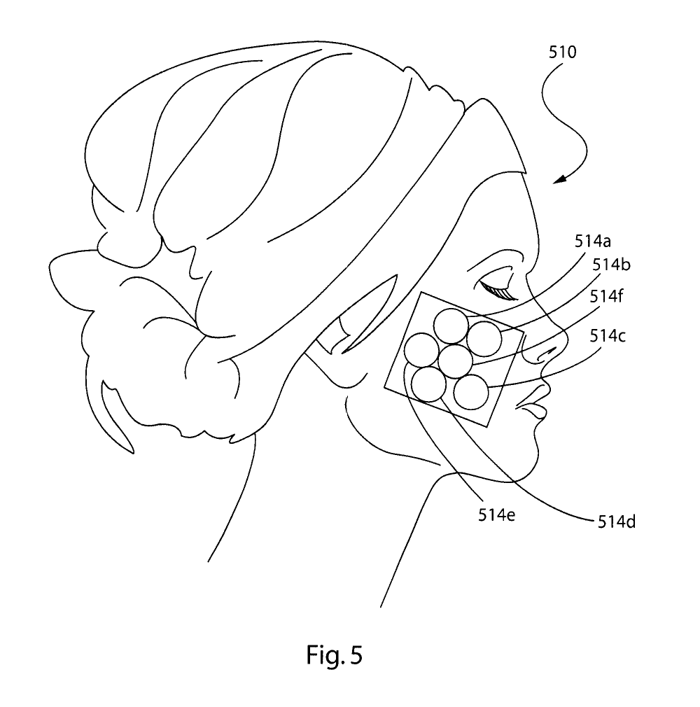

Treatment Protocol (Treatment side of face)—Wet the face with a clean, damp paper towel. Using a new, sterile syringe, apply 0.25 mL of the cleanser (see Table 1) to one side of the face within the boundary 512 defined in FIG. 5. The cleanser was lightly spread within the boundary 512 using a gloved finger. The present study used a skin care device is commercially available within the Doctor's Dermatological Formula® Revolve 400X Micro-Polishing System (The Procter & Gamble Company, Cincinnati, Ohio) with the brush head contained therein. A new brush head was provided with each use. The device was set to a low setting (i.e., brush head rotating at approximately 300 rpm). The applicator brush head is wetted with water. The brush surface is contacted to the side of the face with the cleanser. The device is activated. The brush surface is maintained in contact with the facial skin using gentle pressure for a contact time of about 15 seconds. The face is rinsed with water. The face is allowed to dry, undisturbed for one hour.

TABLE 1

| Ingredient | Wt % |
|---|---|
| Water | QS |
| Glycerin | 15.0000 |
| Lauramidopropyl Betaine | 3.8500 |
| Sorbitol | 2.8000 |
| Carbopol Aqua SF-1 *1 | 5.0000 |
| Polyethylene beads | 3.00000 |
| Jordapon CI Prill *2 | 3.4100 |
| Antil 200 *3 | 2.0000 |
| Citric Acid | 0.6000 |
| Potassium Hydroxide | 0.4500 |
| Polyquaternium-10 | 0.4200 |
| PEG-100 | 0.2000 |
| Disodium EDTA | 0.1200 |
| Sodium Chloride | 0.0550 |
| Kathon CG *4 | 0.0330 |

*1 - Lubrizol Corp., Wickliffe, Ohio
*2 - BASF Corp., Florham Park, NJ
*3 - Evonik, Essen, Germany
*4 - Rohm and Haas Company, Inc. Spring House, PA

Sampling Protocol (Both sides of face)—Sampling is performed according to a set pattern in attempt to avoid sampling overlap. FIG. 5 depicts a sampling matrix used for this test. The boundary 512 of the template is shown on the face 510 of the subject. The boundary 512 delineates the treatment area (for the side of the face receiving treatment) and the sampling area. Six sampling sites 214a-f are shown. FIG. 5 shows the sampling sites for the left side of the face; the sampling sites for the right side are a mirror image of what is shown in FIG. 5. The area of the sampling site corresponds to the size of the cup chamber used to isolate the sample site from the rest of the facial skin. The cup chamber is a specially made glass cylinder with two open ends. The end for skin contact is circular. The cup chamber isolates a 2 cm² area of skin for sampling. During sampling, the subject holds the cup chamber in place using caution not to touch the skin surface being treated. The sample site is swabbed with a clean sterile cotton swab wetted with a sterile 1× phosphate buffered saline with 0.1% (v/v%) Triton X-100 (Dow Chemical Comp., Midland, Mich.). The sample site is contacted with the wetted tip of the swab using even consistent pressure. The swab is moved in a cross-hatched pattern for 10 seconds. The end of swab is cut off with sterile scissors and the swab tip is placed into a 15 ml Falcon™ conical tube. 5000 μL of a sterile 1× phosphate buffered saline with 0.1% (v/v%) Triton X-100 is added to the tube. The tube is vortexed (e.g., VWR® Vortex Mixer available as catalogue no. 58816-121 from VWR Int'l, LLC, West Chester, Pa.) for approximately 10 seconds. 50 μL sample fluid is applied to a 100 mm diameter enriched tryptic soy agar plate (available from Anaerobe Systems, Morgan Hill, Calif.). Incubate plates for 72 hours at 37° C. in an anaerobic chamber (Coy Laboratory Products, Inc., Grass Lake, Mich.) under anaerobic conditions (0 ppm oxygen gas) using a gas mixture of 85% nitrogen, 5% hydrogen, and 10% carbon dioxide gases. At the end of the incubation period, plates are removed from the anaerobic chamber and individual colonies are counted according to habits and practices of one expert in the field. Counts can be obtained by visual inspection or, as done here, by automated colony counters (such as the ProtoCOL series of automated colony counter available from Microbiology International, Frederick, Md.). A skilled artisan would recognize that care must be given to avoid counting within 2-3 mm of the edge of the plate so as to avoid accidental inclusion of non-colony material, such as imperfections in the plastic body of the plates. Additionally, a skilled artisan would recognize that, if an automated colony counter is employed, the user must ensure that colonies are identified and counted correctly. Otherwise, missed colonies must be counted by visual inspection and added to the colonies counted by the automated colony counter. Once the total colonies on a plate have been counted, the number of colony forming units (CFU) per square centimeter is determined using the following equation:

$$\# C F U s on plate \times \frac{1}{50 μl} \times \frac{5000 μl}{1} \times \frac{1}{2 {cm}^{2}} = \frac{C F U s}{{cm}^{2} of skin}$$

When the study is complete, the average number of CFU/cm² of skin is calculated for each swab from each panelist for each day. Standard error is then calculated and data are plotted.

Test Regimen—All work is to be performed at approximately the same time daily and is typically performed in the morning (generally from 8 AM to 11 AM). The daily specifics of the test regimen are as follows:

Washout—A washout is performed both two days prior and one day prior to the start of sampling. On each day, both sides of the participant's face are washed with Ivory® soap and allowed to air dry.

Day 1—Perform sampling at the day 1 (214a) site on the both sides of the face.

Day 2—No washout is performed. Perform sampling at the day 2 site (214b) on the both sides of the face.

Day 3—One side of the face is left untreated. Treat the other side of the face according to the treatment protocol. Wait one hour. Perform sampling at the day 3 site (214c) on the both sides of the face.

Day 4—One side of the face remains untreated. Treat the other side of the face according to the treatment protocol. Wait one hour. Perform sampling at the day 4 site (214d) on the both sides of the face.

Day 5—One side of the face remains untreated. Treat the other side of the face according to the treatment protocol. Wait one hour. Perform sampling at the day 5 site (214e) on the both sides of the face.

Day 6 & 7—No treatment or sampling.

Day 8—Perform sampling at the day 8 site (214f) on the both sides of the face.

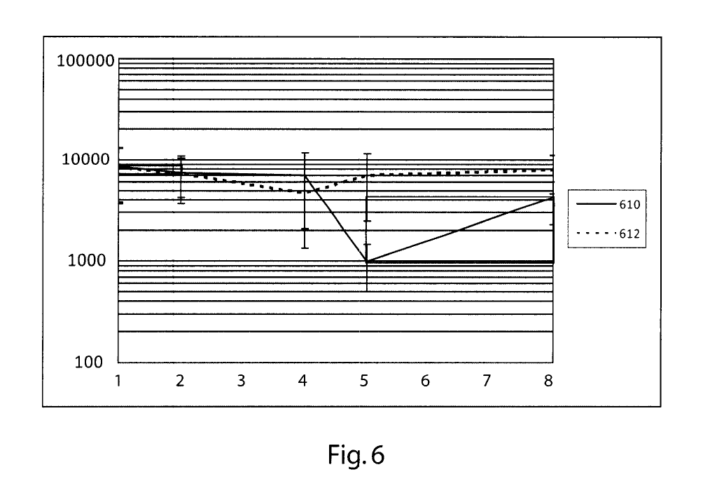

FIG. 6 depicts a plot comparing the average anaerobic bacteria count of the untreated and treated skin surfaces. The data is also provided in Table 2. The treated plot is 610 and the untreated plot is 620. The x-axis shows the days of the study. The y-axis shows the average

TABLE 2
(CFU/cm²)

| Day | Treated | Untreated |
|---|---|---|
| 1 | 8468 [4795]* | 8394 [4637] |
| 2 | 7317 [3645] | 7296 [3098] |
| 4 | 6943 [4842] | 4725 [3402] |
| 5 | 978 [485] | 7010 [4533] |
| 8 | 4188 [1906] | 7903 [3253] |

*Standard error of the mean shown in brackets.

viable anaerobic bacteria count in units of CFU/cm². The plot demonstrates that treating a skin surface with a cleansing composition and an automotive skin care device significantly reduces anaerobic bacteria load. As evidenced by the plot at Days 3 and 4, reduction in anaerobic bacteria load is not immediately seen upon use of the device. Instead, three treatment cycles were needed (Day 5) before a significant reduction in anaerobic bacteria load occurred. Day 5 represents a greater than 7-fold reduction of the anaerobic bacteria load on the treated skin as compared to the untreated anaerobic bacteria load on the same day. Day 5 also represents a greater than 7 fold reduction of the anaerobic bacteria load as compared to the Day 1 baseline of anaerobic bacteria load (either treated or untreated side). No treatment occurred on Days 6 and 7. Testing at Day 8 shows that the anaerobic bacteria load treated skin returned to level close to that of the untreated skin. Therefore, it is believed that routine continued treatment may be needed to maintain a reduced anaerobic bacteria load.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for regulating anaerobic bacteria load on a skin surface comprising the steps of:
a) determining a baseline anaerobic bacteria load of the skin surface;
b) applying a cleansing composition to the skin surface;
c) providing an automotive skin care device, wherein the automotive skin care device comprises:
i) a housing with a handle end extending to an applicator attachment end, the housing contains a motor configured to impart motion to the applicator, and
ii) an applicator coupled to the housing at the applicator attachment end such that motion is imparted to the applicator from the motor, the applicator has a treatment surface;
d) contacting the treatment surface of the applicator to the skin surface for a contact time;
e) rinsing the cleansing composition from the skin surface;
f) repeating steps b-e at least twice over a treatment period; and
g) determining a post-treatment anaerobic bacteria load of the skin surface.

2. The method of claim 1 wherein determining a baseline anaerobic bacteria load of the skin surface further comprises the steps of
i) obtaining a baseline sample of anaerobic bacteria from the skin surface,
ii) culturing the baseline sample under anaerobic conditions, and
iii) counting the anaerobic bacteria colonies to determine a baseline anaerobic bacteria count.

3. The method of claim 1 wherein determining a post-treatment anaerobic bacteria load of the skin surface further comprises the steps of
i) obtaining a baseline sample of anaerobic bacteria from the skin surface,
ii) culturing the baseline sample under anaerobic conditions, and
iii) counting the anaerobic bacteria colonies to determine a baseline anaerobic bacteria count.

4. The method of claim 1 wherein the skin surface is a facial skin surface.

5. The method of claim 1 wherein the steps of applying a cleansing composition to the skin surface and contacting the applicator to the skin surface for a contact time are done concurrently.

6. The method of claim 5 wherein the cleansing composition is first applied to the applicator.

7. The method of claim 1 wherein the cleansing composition is substantially devoid of anti-acne actives.

8. The method of claim 1 wherein the cleansing composition is substantially devoid of benzoyl peroxide, salicylic acid, or combinations thereof.

9. The method of claim 1 wherein the cleansing composition is substantially devoid of antimicrobial agents.

10. The method of claim 1 wherein the step of applying a cleansing composition to the skin surface further comprise applying about 0.1 mL to about 1 mL of the cleansing composition to the skin surface.

11. The method of claim 1 wherein the automotive skin care device further comprises a battery connected to the motor.

12. The method of claim 1 wherein the motion imparted to the applicator from the motor is selected from a group consisting of rotary, vibratory, oscillatory, or reciprocatory.

13. The method of claim 1 wherein the motion imparted to the applicator from the motor is rotary.

14. The method of claim 1 wherein the contact time is at least 15 seconds.

15. The method of claim 1 wherein the treatment surface of the applicator comprises bristles.

16. The method of claim 1 wherein the treatment surface of the applicator comprises foam.

17. The method of claim 1 wherein the treatment period is at least three days.

18. The method of claim 17 wherein the repeating of steps b-e is done at an interval of about 12-36 hours.

19. The method of claim 18 wherein the repeating of steps b-e is done at a daily interval.

20. The method of claim 1 wherein the post-treatment anaerobic bacteria load is reduced by at least seven-fold as compared to the baseline anaerobic bacteria load.

21. A method for regulating anaerobic bacteria load on a skin surface comprising the steps of:
a) applying a cleansing composition to the skin surface, wherein the cleansing composition is substantially devoid of anti-acne actives;
b) providing an automotive skin care device, wherein the automotive skin care device comprises:
i) a housing with a handle end extending to an applicator attachment end, the housing contains a battery connected to a motor, wherein the motor is configured to impart rotational motion to the applicator, and
ii) an applicator coupled to the housing at the applicator attachment end such that motion is imparted to the applicator from the motor, the applicator has a treatment surface comprising bristles;
c) contacting the treatment surface of the applicator to the skin surface for at least 15 seconds;
d) rinsing the cleansing composition from the skin surface with water; and
e) repeating steps a-d at least twice with a daily interval.

22. The method of claim 21 further comprising the steps of:
determining a baseline anaerobic bacteria load of the skin surface;
determining a post-treatment anaerobic bacteria load of the skin surface.

23. The method of claim 22 wherein the baseline anaerobic bacteria load is reduced by reduced by at least seven-fold as compared to the post-treatment baseline anaerobic bacteria load.
